(19) United States
(12) Patent Application Publication
(10) Pub. No.: US 2023/0406141 A1
(43) Pub. Date: Dec. 21, 2023

(54) VEHICLE DETECTION SYSTEM

(71) Applicant: LTS LIGHT TECHNIC SOLUTION AG, SIRNACH (CH)

(72) Inventors: Thomas Langer, SIRNACH (CH); Emanuell Tomes, Bettwiesen (CH); Georg Brügger, Schaffhausen (CH); Daniel Britt, Winterthur (CH)

(73) Assignee: LTS LIGHT TECHNIC SOLUTION AG, SIRNACH (CH)

(21) Appl. No.: 18/272,106

(22) PCT Filed: Jan. 29, 2021
(86) PCT No.: PCT/EP2021/052182

§ 371 Date: Jul. 13, 2023

(51) Int. Cl. B60L 53/66; B60L 53/62

(52) U.S. Cl. CPC B60L 53/66; B60L 53/62

(57) ABSTRACT

A vehicle detection system for monitoring stationary and moving vehicles is disclosed. The vehicle detection system includes a housing and a first sensor and a second sensor each configured to detect the moving vehicles. A control unit, and a first energy store as well as a second energy store configured to supply the vehicle detection system with electrical energy independently of one another are also provided. The control unit is designed in such a way that the first sensor is permanently switched on during operation of the vehicle detection system and the second sensor is only switched on for a predetermined time when the first sensor has detected a vehicle. The control unit is designed in such a way that, when the voltage of the first energy store falls below a first predetermined voltage, the vehicle detection system is supplied with electrical energy by the second energy store.

### CROSS REFERENCE TO RELATED APPLICATIONS

This application is a national phase of International Application No.: PCT/EP2021/052182, filed Dec. 29, 2021, the content of all of the aforementioned being herein incorporated by reference.

### BACKGROUND OF THE INVENTION

### Field of the Invention

The invention relates to a vehicle detection system for monitoring stationary and moving vehicles.

### Description of Related Art

Vehicle detection systems for detecting and guiding vehicles are well-known from patent literature, both for moving and stationary traffic. So-called traffic guidance systems or parking guidance systems serve to draw the attention of vehicle drivers, for example, from places with high traffic density to bypasses or, in agglomerations, to guide them to parking spaces with free capacity. Such vehicle detection systems can include ground sensors that register a vehicle when it approaches or passes over a parking space and then transmit the corresponding information to a guidance system.

Conventional ground sensors can be wired for their power supply or for their communication with a control system, which means that when installing such ground sensors, in addition to their anchoring to the ground, cables must also be laid for the power supply and communication, which is associated with a corresponding expense in terms of installation time and installation material. In order to reduce this effort, modem vehicle detection systems are built with ground sensors that can perform one-way or two-way communication with a control system via radio signals and also comprise their own power supply. Such ground sensors then only require their own installation at a desired location on traffic routes or parking lots.

It is important for vehicle detection systems to be designed for their intended use. For example, vehicle detection systems designed to detect stationary traffic are typically not suitable for the far more complex detection of moving traffic. This is due, among other things, to the fact that moving vehicles at higher speeds are only in the range of the sensor system for a very short time and can be detected by it. The correct detection of different vehicle types is also challenging: Thus, compact passenger cars up to long trucks, each with and without trailer, must be correctly detected. When traffic is stationary, e.g. in parking lots, the vehicles remain within the range of the sensor for a much longer period of time, and it is usually not necessary to distinguish between different vehicle types.

In this context, EP 3 543 984 A1 (its light technik solutions AG) describes a vehicle detection system or ground sensor for monitoring stationary as well as moving traffic. The system includes an occupancy sensor for detecting a vehicle, an energy store, a microprocessor and a communication module, whereby the energy store can be supplied with energy from an RF energy converter by means of RF transmission energy. Also mentioned for powering are solar cells, peltier elements, and RF charge pumps. The occupancy sensor can be a PIR sensor (motion detector), radar sensor, pressure sensor, magnetic field sensor, ultrasonic sensor or a capacitive, inductive or optical sensor. PIR sensors are particularly advantageous. Batteries or supercapacitors (supercaps) are mentioned as energy stores. Also shown is a voltage monitoring system that allows early detection of faults in the power supply to the ground sensor and, if necessary, the connection or disconnection of individual or multiple power supplies.

However, a disadvantage of such a vehicle detection system is that a relatively high transmitting power is required to supply the energy store with sufficient energy via the RF energy converter. This can be problematic depending on the installation situation of the system. The optional solar cells and Peltier elements mentioned for additional power supply can supply additional energy, but their performance is highly dependent on the weather. RF charge pumps, which are also a possibility for supplying the energy storage device with energy, require manual intervention directly at the installation site, which is time-consuming and undesirable, especially on busy traffic routes.

Another problem is that if the energy store malfunctions, the entire vehicle detection system fails and can no longer supply data. Accordingly, such systems, like other known vehicle detection systems, must be checked and maintained at relatively short intervals to ensure trouble-free operation. This is particularly undesirable in the case of vehicle detection systems integrated in roadways, since the road surfaces have to be opened for maintenance in order to provide access to the vehicle detection system.

There is therefore still a need for improved solutions that comprise the above-mentioned disadvantages to a lesser extent or not at all.

### BRIEF SUMMARY OF THE INVENTION

The object of the invention is therefore to provide a vehicle detection system which is designed to detect moving traffic, enables vehicles to be detected as precisely as possible and requires as little maintenance as possible.

A core of the invention is a vehicle detection system for monitoring stationary and moving vehicles, having a housing, a first sensor and a second sensor, in each case for detecting vehicles, a control unit and a first energy store and a second energy store, which can supply the vehicle detection system with electrical energy independently of one another, the control unit being designed in such a way that the first sensor is switched on permanently during operation of the vehicle detection system and the second sensor is switched on for a predetermined time only when the first sensor has detected a possible vehicle. The control unit is also designed in such a way that when the voltage of the first energy store falls below a first predetermined value, the vehicle detection system is supplied with electrical energy by the second energy store.

In other words, the vehicle detection system has two separate energy storage devices that can supply the system with energy independently of each other.

In normal operation, the vehicle detection system is supplied with energy via the first energy store. By monitoring the first energy store, the control unit can detect any faults at an early stage and ensure an uninterrupted power supply via the second energy store. This ensures that the vehicle detection system can be supplied with energy even in the event of a short- or long-term malfunction of the first energy store.

Furthermore, the vehicle detection system is designed in such a way that the first sensor is permanently switched on during operation of the vehicle detection system and the second sensor is only switched on for a predetermined time when the first sensor has detected a vehicle. This enables a particularly energy-efficient and precise detection of moving as well as stationary vehicles. With such a two-stage sensor system, the vehicle detection system can thus be operated in a particularly energy-saving manner without having to compromise on detection accuracy.

While the first sensor is permanently switched on during operation of the vehicle detection system, it preferably performs a measurement at regular distances, in particular at a frequency of more than 50 Hz, for example 50-200 Hz, in particular 100 Hz. The second sensor is preferably switched on within less than 10 milliseconds, in particular less than 1 millisecond, in particular less than 0.5 milliseconds, preferably less than 0.1 milliseconds, after the first sensor has detected a vehicle. This ensures that moving vehicles can be detected precisely even at higher speeds.

Since even non-contact sensors are subject to a certain amount of wear during operation, e.g. due to increased temperatures during operation, the service life of the second sensor can be considerably extended by the two-stage sensor system according to the invention, which means that the susceptibility of the vehicle detection system to faults can be reduced overall. If, for example, a first sensor, which is not very problematic in terms of wear, is combined with a more wear-intensive sensor, an extremely long service life of the sensor system can be achieved.

Together with the two separate energy stores, this results in a vehicle detection system that comprises a particularly long service life and correspondingly long maintenance intervals.

Furthermore, the two-stage sensor system makes it possible to design the controller in such a way that if one of the two sensors fails, the vehicle detection system continues to operate with the functioning sensor. Under certain circumstances, this can lead to increased energy consumption and/or reduced precision during detection. However, a total failure of the vehicle detection system can be prevented or at least greatly delayed.

The combination of two separate energy stores, a two-stage sensor system and the control unit according to the invention enables the provision of unexpectedly advantageous vehicle detection systems. These can be operated in an extremely energy-saving manner and have maintenance intervals of several years. Accordingly, such systems according to the invention are ideally suited for use in difficult-to-access locations with high traffic density.

Energy converters, with which transmission energy is made usable for supplying or charging an energy storage device, can be dispensed with accordingly. Advantageously, the vehicle detection system is therefore not designed to use transmission energy, in particular RF transmission energy, to supply or charge an energy store. In particular, the vehicle detection system does not have an RF energy converter for supplying or charging an energy store. However, if required, such energy converters can still be used for special applications.

In particular, the first and second sensors are each an infrared sensor, an ultrasonic sensor, a laser-based sensor, a microwave-based sensor, a magnetic field sensor, a Hall sensor and/or an induction loop for vehicle detection. In particular, the first sensor and the second sensor are different sensors, especially sensors based on different technologies.

The evaluation of the signals from the individual sensors in the area of vehicle detection is in itself known to the person skilled in the art. Accordingly, known knowledge can be used in this regard.

According to a particularly advantageous embodiment, the first sensor is a magnetic field sensor and the second sensor is a microwave-based sensor, in particular a radar sensor. The magnetic field sensor is e.g. a Hall sensor.

operated in a particularly energy-saving manner and at the same time achieve high precision in vehicle detection. This is likely to be related to the fact that magnetic field sensors can detect the presence of a vehicle very reliably, regardless of type. Both compact vehicles with low-lying chassis and trucks with high-lying chassis can be reliably detected. This makes the magnetic field sensor suitable as a reliable trigger for activating the second sensor.

In the microwave-based sensor, which is preferably provided as a second sensor, a so-called primary signal is emitted as a bundled electromagnetic wave and the echoes reflected by objects are received as a secondary signal. From this, for example, the distance to the vehicle, its speed and/or length can be determined. In the present case, a microwave-based sensor provides extremely precise data on moving vehicles. In addition, microwave-based sensors can be activated in a very short time, which is crucial for the detection of high-speed vehicles.

The combination of magnetic field sensor and microwave-based sensor, in particular a radar sensor, has proved to be particularly advantageous for most areas of application of the vehicle detection system compared with other sensor combinations. However, other sensor combinations can also be advantageous for special applications.

The control unit is preferably designed in such a way that:
The first sensor performs a measurement at regular intervals, in particular with a frequency of more than 50 Hz, for example 50-200 Hz, in particular 100 Hz;
The measured data is compared with a predefined sensor threshold value;
A measurement algorithm starts when a measured value is above the predefined sensor threshold value,
The measurement algorithm, in particular if the measured data obtained with the first sensor meet a predefined condition, activates the second sensor and performs at least one measurement;
The measured data obtained with the first and/or with the second sensor are evaluated by the control unit, so that one or more measured quantities are obtained;
Preferably, the second sensor is switched off after each measurement and is only reactivated for a new measurement if required.

The predefined condition in step d) can be e.g. a minimum time period of exceeding the sensor threshold value. However, completely different conditions can also be predefined.

A measurement algorithm is started in step c), the second sensor is activated and the at least one measurement is performed in step d), in particular within less than 10 milliseconds, in particular less than 1 millisecond, in particular less than 0.5 milliseconds, preferably less than 0.1 milliseconds, after the threshold value has been compared in step b).

Step f) increases the energy efficiency of the vehicle detection system, especially if the first sensor is a magnetic field sensor and the second sensor is a microwave-based sensor, for example a radar sensor.

According to another advantageous embodiment, the first sensor comprises two separate magnetic field sensors that can be operated alternatively. This means that if one magnetic field sensor fails, the other magnetic field sensor can be used. In this case, the controller is preferably designed in such a way that in the event of a failure of the first magnetic field sensor, the system automatically switches to the second magnetic field sensor.

The first and the second energy store are in particular each an electrical energy store.

Particularly preferred is the first energy store a rechargeable energy store, in particular a capacitor and/or a first accumulator. A capacitor is particularly preferred, in particular a supercapacitor. A supercapacitor is in particular a double-layer capacitor.

Capacitors can be charged and discharged much faster than accumulators. In addition, they can withstand more switching cycles than accumulators and are therefore particularly suitable for the vehicle detection system according to the invention.

In principle, the first energy store can also be a battery, which is not rechargeable.

Preferably, the vehicle detection system has at least one charging element that is designed to charge the first energy store, and optionally also the second energy store. It is particularly preferred if both the first and the second energy store can be charged by the at least one charging element.

In particular, the at least one charging element is a solar cell, an induction loop and/or a Peltier element.

The charging element can charge the first energy store and/or the second energy store, in particular an accumulator and/or a capacitor. In the case of a solar cell, the first energy store, and optionally also the second energy store, can be charged automatically at times of sufficient sunlight. Peltier elements are known per se. They generate a current flow in the event of a temperature difference due to the Seebeck effect.

If both a Peltier element and a solar cell are present, the Peltier element is preferably coupled to the solar cell via a thermally conductive thermal bridge. This is because solar modules heat up when exposed to sunlight and thus a larger, electrically usable temperature delta is available for the Peltier element than if it is arranged separately from the solar cell.

With an induction loop, the first energy store, and optionally also the second energy store, can be charged by external magnetic fields. According to a particularly advantageous embodiment, the vehicle detection system has an induction loop, preferably in the form of an induction coil, with which external sources of interference, e.g. from electric vehicles, can be used for energy generation.

Particularly preferably, the second energy store is an accumulator or a battery. If the first energy store is also an accumulator or a battery, the second energy store is another accumulator or another battery. In other words, there are at least two separate accumulators or batteries in this case.

The following configuration is particularly preferred:
The first energy store is an accumulator and/or a capacitor, preferably a capacitor, more preferably a supercapacitor;
The second energy store is an accumulator or battery;
The at least one charging element includes a solar cell, optionally in combination with a Peltier element;
The first sensor is a magnetic field sensor;
The second sensor is a microwave-based sensor, in particular a radar sensor.

The control unit is designed in such a way that when the voltage of the first energy store falls below a first predetermined value, the vehicle detection system is supplied with electrical energy by the second energy store. In this case, the energy supply via the first energy store is preferably completely prevented.

Preferably, the control unit is designed in such a way that it switches on either the first energy store or the second energy store for energy supply, but not both energy stores simultaneously.

In particular, the control unit is designed to continuously monitor the voltage of the first energy store and to supply power to the vehicle detection system via the second energy store when the voltage falls below the first predetermined voltage. The first predetermined voltage may also be referred to as the first threshold value. In an advantageous embodiment, the actual voltage of the second energy source serves as the first predetermined voltage or the first threshold value. In other words, in this case the vehicle detection system is supplied by the second energy store when the voltage of the first energy store is lower than the voltage of the second energy store.

This ensures that the energy supply to the vehicle detection system is automatically provided via the second energy store in the event of a fault in the first energy store, e.g. in the event of a defect, discharge or the like.

It is also preferred if the control unit is designed in such a way that the vehicle detection system is supplied by the first energy store when a second predetermined voltage of the first energy store is exceeded. In an advantageous embodiment, the actual voltage of the second energy source serves as the second predetermined voltage or as the second threshold value. In other words, in this case the vehicle detection system is supplied by the first energy store when the voltage of the first energy store is higher than the voltage of the second energy store.

Thus, when the first energy store recovers, as indicated by the rising voltage, the control unit automatically switches back to the first energy store. The vehicle detection system then operates in normal mode again and is completely supplied with energy by the first energy store.

The control unit is particularly preferably designed in such a way that:
when the voltage of the first energy store falls below a first predetermined voltage, the vehicle detection system is supplied with electrical energy by the second energy store; and
when a second predetermined voltage of the first energy store is exceeded, the vehicle detection system is supplied by the first energy store;
wherein preferably either the first energy store or the second energy store is connected to supply energy, but not both energy stores simultaneously.

According to a further advantageous embodiment, the vehicle detection system has a communication interface, in particular a wireless communication interface. The communication interface is particularly preferably a bidirectional communication interface.

A communication interface can be used to send data from the vehicle detection system to a higher-level communication device, e.g. a gateway and/or a control system. The data can be e.g. measured quantities, data on the status of the vehicle detection system, error information and/or maintenance information. In this way, the status of the individual components of the vehicle detection system can be monitored remotely. If, for example, one of the two sensors fails or the voltage of one of the energy stores drops unexpectedly, appropriate measures can be initiated.

A bidirectional communication interface can also be used to transfer data remotely, e.g. from a control system and/or from a gateway, to the vehicle detection system. This makes it possible, for example, to reprogram and/or reparameterize the control unit and/or other components of the vehicle detection system. This is done without having to physically access the vehicle detection system at the installation site. In the event of a fault, for example, the control unit can be reprogrammed in such a way that if one of the two sensors fails, the vehicle detection system continues to operate with the functioning sensor. It is also possible to adapt or optimize the sensor sensitivities to the conditions at the installation site of the vehicle detection system.

If a bidirectional communication interface is available, the control unit is preferably designed in such a way that the two sensors can be switched on and off, the sensor sensitivities can be adjusted and/or the measurement algorithm can be changed via the bidirectional communication interface.

A wireless communication interface includes, for example, a radio, a Bluetooth and/or a WLAN communication interface. However, other communication interfaces can also be used.

The housing of the vehicle detection system preferably has a side wall, preferably a cylindrical wall, as well as a top and bottom surface. Cylindrical vehicle detection systems can be installed reliably and in a space-saving manner in corresponding circular-cylindrical roadway recesses, e.g. drilled holes in the roadway, which is extremely efficient. In principle, however, differently shaped housings can also be used.

The top surface of the housing preferably consists at least partially of a light-transmitting material, preferably glass, in particular a toughened safety glass. This makes it possible to place a solar cell and/or a light-sensitive sensor in the housing.

Advantageously, the housing has a bottom surface projecting beyond the lateral wall. In particular, the bottom surface has a larger circumference than the side wall, especially the cylindrical wall. This allows the housing to be better anchored in the roadway recesses, preventing the vehicle detection system from being easily levered out under mechanical and/or thermal loads.

In particular, rib-like protrusions extending vertically and outwardly are attached to the housing. This prevents the sensor from twisting after installation in a roadway.

It is also advantageous if the bottom surface has at least one, preferably several, recesses and/or at least one, preferably several, passages. The at least one recess and/or the at least one passage are preferably present in the areas of the bottom surface projecting beyond the lateral wall. This simplifies the casting of the vehicle detection system in the roadway recesses, since the casting compound can flow under the vehicle detection system when it is inserted through the recesses and/or passages.

The alignment of the vehicle detection system during installation can be realized with an installation aid. The installation aid can, for example, be a support element that can be placed on the road surface in the area next to the roadway recesses and to which the vehicle detection system can be temporarily attached. This allows the sensor to be optimally embedded in the road surface without it coming to rest too deeply or protruding beyond the road surface. The latter would be a problem, for example, when clearing snow and would lead to unnecessary additional mechanical loads when driving over it. Preferably, the housing has mounting fixtures via which the vehicle detection system can be mechanically connected to the installation aid during installation.

According to a first advantageous embodiment, the bottom surface, top surface and side wall are materially bonded together. This makes it possible to achieve a particularly good seal so that the components of the vehicle detection system are optimally protected against the effects of the weather. With this design, the vehicle detection system must be completely dismantled in the event of a defect and the materially bonded connection released.

In a second advantageous embodiment, the top surface is releasably connected, in particular screwed, to the side wall. In the event of a defect, the top surface can be removed relatively easily, giving access to the individual components of the system. Defective parts, e.g. the control unit and/or a glass, can thus be replaced without great effort, which minimizes the duration of the associated lane closure.

It is also preferred if the housing has a pressure equalization device. This prevents an overpressure or underpressure from building up in the housing in the event of changing weather conditions, e.g. fluctuations in air pressure or temperature.

Preferably, at least one passage, in particular a continuous bore, is provided in the housing as a pressure equalization device. The at least one passage is preferably designed as an air-permeable and at the same time liquid-impermeable connection between the outside and inside of the housing. In particular, the at least one passage is closed with an air-permeable and liquid-impermeable membrane.

### BRIEF DESCRIPTION OF THE SEVERAL VIEWS OF THE DRAWINGS

Further advantageous features and details of the various embodiments of this disclosure will become apparen from the ensuing description of preferred exemplary embodiment or embodiments and further with the aid of the drawings. The features and combinations of features recited below in the description, as well as the features and feature combinations shown after that in the drawing description or in the drawings alone, may be used not only in the particular combination recited by also in other combinations on their own without departing from the scope of the disclosure.

The following is an advantageous embodiment of the invention with reference to the accompanying drawings wherein:

FIG. 1 A block diagram of a vehicle detection system according to the invention in the form of a ground sensor with a magnetic field sensor and a radar sensor;

FIG. 2 A block diagram of a further ground sensor according to the invention which has two redundant magnetic field sensors;

FIG. 3 A perspective view of the housing of the ground sensor of FIG. 1;

FIG. 4 A schematic representation of the installation situation after the ground sensor in FIG. 3 has been cast into a recess in a roadway.

In principle, the same parts are provided with the same reference signs in the figures.

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of “A, B, and C” should be understood as including not only one of A, only one of B, only one of C, or any combination of A, B, and C.

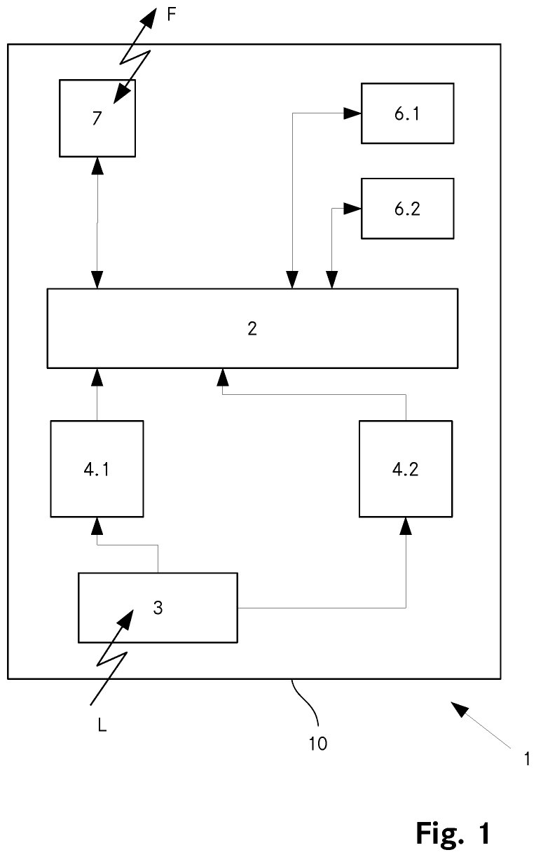

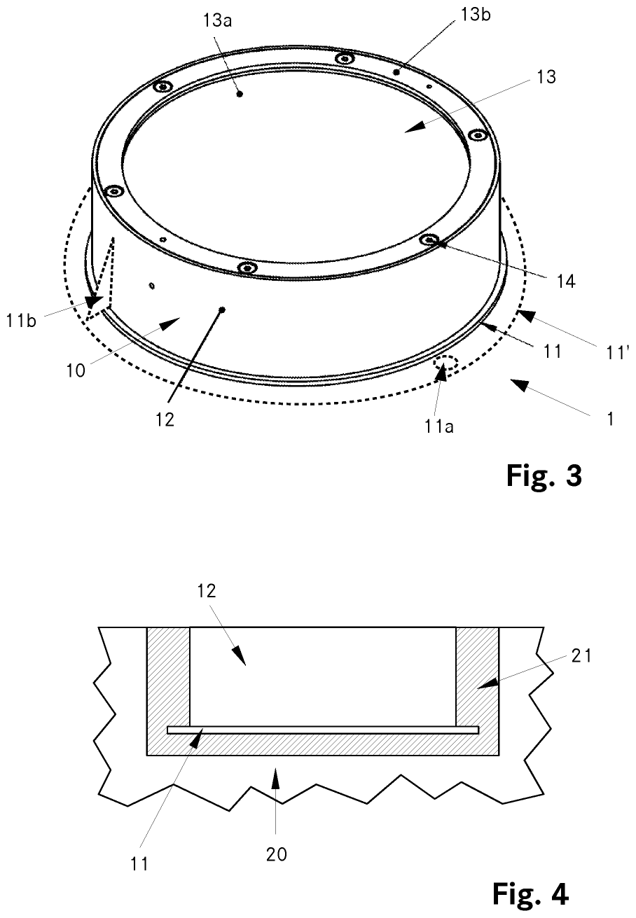

FIG. 1 shows a vehicle detection system according to the invention schematically by means of a block diagram. The vehicle detection system is in the form of a ground sensor 1, which is housed in a housing 10 (see FIG. 3 for details of the housing).

The ground sensor 1 has a first sensor 6.1 in the form of a magnetic field sensor (Hall sensor) and a second sensor 6.2, which is a radar sensor. The first energy store 4.1 is a supercapacitor, while the second energy store 4.2 is an accumulator. The two energy stores 4.1, 4.2 can be supplied with current and charged via a charging element 3, in this case a solar cell, when it is illuminated by light L. The energy store 4.2 can be charged when the light L shines on it.

The ground sensor 1 also comprises a central control unit 2, which has a computing unit, a data memory and several interfaces for data exchange with the other components of the ground sensor and for power supply. The two sensors 6.1, 6.2 are connected to the control unit 2 via communication lines, while the two energy stores 4.1, 4.2 are connected to the control unit via supply lines.

The control unit 2 is designed in such a way that
if the voltage of the first energy store 4.1 falls below the voltage of the second energy store 4.2, the ground sensor or its components are supplied with electrical energy by the second energy store 4.2, and
when the voltage of the first energy store 4.1 rises again above the voltage of the second energy store 4.2, the ground sensor or its components are supplied by the first energy store 4.2.

Furthermore, the control unit 2 is designed in such a way that:
the first sensor 6.1 carries out a measurement at regular intervals, in particular at a frequency of 100 Hz;
The measured data is compared with a predefined sensor threshold value;
A measurement algorithm starts when a measured value is above the predefined sensor threshold,
Whereby, if the measured data obtained with the first sensor 6.1 meets a predefined condition, the measurement algorithm activates the second sensor 6.2 and performs at least one measurement;
The measured data obtained with the two sensors 6.1, 6.2 are evaluated by the controller 2 so that one or more measured quantities are obtained;
Whereby the second sensor 6.2 is switched off after each measurement and is only activated again for a new measurement if required.

The start of the measurement algorithm in step c), the activation of the second sensor and the execution of the at least one measurement in step d) take place, for example, within less than 1 millisecond, after the comparison of the threshold value in step b).

The control unit 2 is also connected to a communication module 7, which enables a bidirectional data exchange via a wireless connection, for example a radio network, with a gateway or a control station (not shown) via corresponding radio signals F.

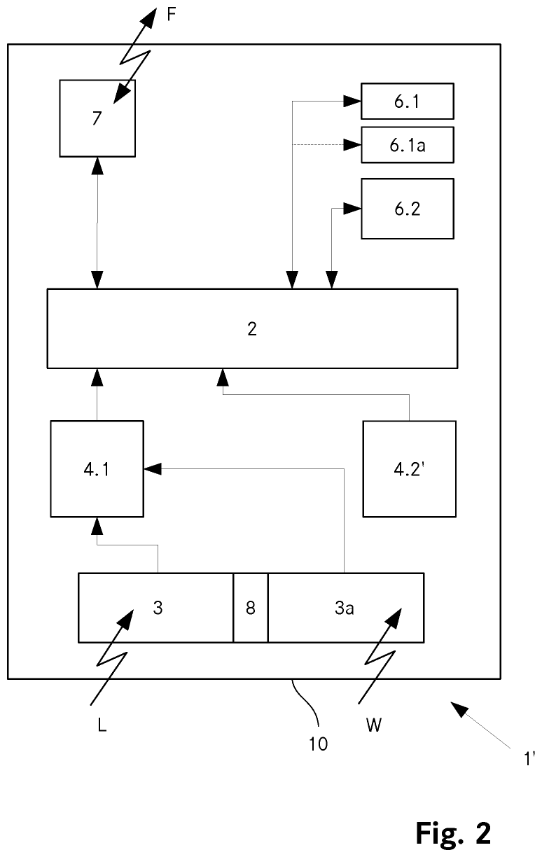

FIG. 2 shows a second ground sensor 1′, in which a further magnetic field sensor 6.1a of identical design is present in addition to the first sensor 6.1. The controller 2 is additionally designed in such a way that in the event of a failure of the first magnetic field sensor 6.1, the system automatically switches to the second magnetic field sensor 6.1a.

Furthermore, in addition to the charging element 3 or the solar cell, the ground sensor 1′ also has a further charging element 3a in the form of a Peltier element which utilizes thermal energy W to charge the supercapacitor. The Peltier element is in contact with the solar cell or the first charging element 3.1 via a good conductive thermal bridge 8. The first energy store 4.1 or the supercapacitor can thus additionally be charged via the Peltier element. Instead of a second energy store in the form of an accumulator, a non-rechargeable battery is present in the ground sensor 1 as the second energy store 4.2′. Accordingly, the battery is not connected to the charging elements 3.1, 3.1a.

The other components of the ground sensor 1′ are identical in construction to the respective components of the first ground sensor 1.

FIG. 3 shows a perspective view of the housing 10 of the ground sensor 1 from FIG. 1. The housing 10 consists of a bottom surface 11, a cylindrical side wall 12 and a top surface 13. The top surface 13 contains a central glass plate 13a made of toughened safety glass, which rests on the side wall 12 and is fixed by a fastening ring 13b. The fastening ring is releasably connected to the side panel 12 by a total of six screws 14. The fastening ring also contains a pressure equalization device 15 in the form of a hole closed by an air-permeable and water-impermeable membrane.

Directly below the glass plate 13a, the first charging element 3 in the form of the solar cell is mounted inside the housing 10 (not visible in FIG. 3), and below it are the remaining components.

As can be seen in FIG. 3, the bottom surface 11 projects beyond the side wall 12 in a lateral direction, or the bottom surface 12 has a larger circumference than the side wall 12. This means that the ground sensor 1 can be cast in a form-fitting manner into a road surface 20 using a casting compound 21, for example, as shown in FIG. 4.

The embodiments described above are to be understood merely as illustrative examples, which may be modified as desired within the scope of the invention.

For example, the second energy store 4.2 in FIG. 1 may be a non-rechargeable battery instead of an accumulator. Similarly, the second energy store 4.2′ in FIG. 2 may be in the form of an accumulator instead of a non-rechargeable battery.

Instead of a mounting ring 13b, the light-transmitting glass plate 13a in the embodiment of FIG. 3 may, for example, also be bonded directly to an inner and lowered section of the side wall 12, so that a non-releasable connection is present.

It is also possible to provide a larger bottom surface 11′ (indicated by broken lines in FIG. 3) for the housing shown in FIG. 3, which projects even further beyond the cylindrical side wall. This further improved the retention of the housing in the base. Passages 11a can also be provided in the edge region of the bottom surface 11′, which simplifies casting of the housing in roadway recesses.

In addition, rib-like projections 11b (indicated by broken lines in FIG. 3) running in the vertical direction can be provided, which project from the side wall 12 of the housing and secure it against twisting.

The bottom surfaces 11, 11′ do not necessarily have to be flat as shown in FIG. 3. It is also possible that they comprise a curved or corrugated surface. It is also possible that the bottom surfaces 11, 11′ are angled upwards or downwards at the edge areas, while the central area is flat, for example.

Likewise, the housing of FIG. 3 can also be cuboidal instead of cylindrical.

The scope of protection of the present invention is given by the claims and is not limited by the features illustrated in the description or shown in the figures.

What is claimed is:

1. A vehicle detection system for monitoring stationary and moving vehicles, the vehicle detection system comprising:
a housing,
a first sensor and a second sensor configured and arranged to detect the vehicles,
a control unit,
a first energy store and a second energy store configured and arranged to supply the vehicle detection system with electrical energy independently of one another, and
wherein the control unit is configured to permanently switch on the first sensor during operation of the vehicle detection system and to switch on the second sensor for a predetermined time only when the first sensor detected a vehicle, and
wherein the control unit is configured such that when a voltage of the first energy store falls below a first predetermined voltage, the vehicle detection system is supplied with electrical energy by the second energy store.

2. The vehicle detection system according to claim 1, wherein the first sensor is a magnetic field sensor and the second sensor is a radar sensor.

3. The vehicle detection system according to claim 1, wherein the first energy store is a rechargeable energy store, a supercapacitor or an accumulator.

4. The vehicle detection system according to claim 3, wherein the vehicle detection system comprises at least one charging element configured to charge the first energy store.

5. The vehicle detection system according to claim 4, wherein the at least one charging element comprises at least one of a solar cell, an induction loop and a Peltier element.

6. The vehicle detection system according to claim 1, wherein the control unit is configured such that when a second predetermined voltage of the first energy store exceeded, the vehicle detection system is supplied by the first energy store.

7. The vehicle detection system according to claim 1, wherein the second energy store is an accumulator or a battery.

8. The vehicle detection system according to claim 4, wherein the second energy store is configured to be charged by the at least one charging element.

9. The vehicle detection system according to claim 1, wherein the vehicle detection system further comprises a wireless communication interface.

10. The vehicle detection system according to claim 9, wherein the wireless communication interface is a bidirectional communication interface.

11. The vehicle detection system according to claim 1, wherein the housing further comprises:
a cylindrical wall;
a top surface; and
a bottom surface.

12. The vehicle detection system according to claim 11, wherein the top surface comprises at least a partially light-transmitting material.

13. The vehicle detection system according to claim 11, wherein the bottom surface comprises a larger circumference than the cylindrical wall.

14. The vehicle detection system according to claim 13, wherein the bottom surface comprises at least one recess and/or at least one passages.

15. The vehicle detection system according to claim 14, wherein the at least one recess and/or the at least one passage is arranged in regions of the bottom surface projecting beyond a lateral wall.

16. The vehicle detection system according to claim 11, wherein the top surface comprises, at least partially, of glass.

17. The vehicle detection system according to claim 7, wherein the second energy store is configured to be charged by at least one charging element.
